(19) United States
(12) Patent Application Publication
(10) Pub. No.: US 2026/0105536 A1
(43) Pub. Date: Apr. 16, 2026

(54) PROBABILISTIC CLASSIFICATION OF TAX CATEGORIES

(71) Applicant: Vertex, Inc., King of Prussia, PA (US)

(72) Inventors: Bob Maeser, Eagan, MN (US); Adam Polak, Brooklyn, NY (US)

(21) Appl. No.: 19/344,075

(22) Filed: Sep. 29, 2025

Related U.S. Application Data
(60) Provisional application No. 63/705,919, filed on Oct. 10, 2024.

(51) Int. Cl. G06Q 40/12

(52) U.S. Cl. CPC G06Q 40/123

(57) ABSTRACT

A computing system for probabilistic classification of tax categories includes processing circuitry that implements a probabilistic tax category classification program. The processing circuitry receives a query to determine a tax category for a product and sends a prompt to a tax category prediction language model, instructing the model to predict a tax category for the product. The processing circuitry receives a subset of tax categories and respective probability scores for each tax category. A calibration and probabilistic classification module calibrates the respective probability scores by generating a posterior probability distribution, determining an entropy and a variance of the posterior probability distribution, and calculating a respective combined confidence score for each tax category. The processing circuitry receives a predicted tax category and its respective combined confidence score, and, based on the combined confidence score for the predicted tax category, outputs a final tax category for the product.

### CROSS REFERENCE TO RELATED APPLICATIONS

This application claims priority to U.S. Provisional Patent Application Ser. No. 63/705,919, filed Oct. 10, 2024, the entirety of which is hereby incorporated herein by reference for all purposes.

### BACKGROUND

Tax categorization refers to the process of determining a tax category for a product or material. Current practices in tax categorization for products and materials are largely manual, which can lead to errors in categorization and downstream risks, such as the potential for audits and penalties. Manual categorization is also inefficient at scale, and can hinder organizational agility. Businesses face substantial challenges in keeping pace with dynamic product catalogs and evolving tax regulations, which are complicated by diverse global jurisdictions. The reliance on high-skill tax departments for repetitive, low-skill tasks leads to poor resource allocation and prevents scaling and integration of more effective systems. Furthermore, tax departments often work with limited data, necessitating time-consuming research to determine the proper tax categories for products and exacerbating the risk of costly errors. As such, a technical challenge exists to provide a computing system that can simplify the tax categorization process, enhance accuracy, and reduce the operational burden on tax departments.

### SUMMARY

To address the above issues, systems and methods for a probabilistic approach to classifying tax categories using generative artificial intelligence and calibration techniques are disclosed herein. According to one aspect, a computing system for probabilistic classification of tax categories is provided. The computing system includes processing circuitry configured to execute instructions using portions of associated memory to implement a probabilistic tax category classification program. The processing circuitry is configured to receive a query to determine a tax category for a product. The query includes product information related to the product. The processing circuitry is further configured to send a prompt to a tax category prediction language model. The prompt includes the product information and instructs the tax category prediction language model to predict a tax category for the product based on the product information. The processing circuitry receives, as output from the tax category prediction language model, a subset of tax categories of a plurality of tax categories with respect to a tax category classification of the product, and respective probability scores for each tax category of the subset of tax categories. A calibration and probabilistic classification module is implemented to calibrate the respective probability scores output by the tax category prediction language model. The calibration and probabilistic classification module is configured to generate a posterior probability distribution by incorporating historical accuracy data for each tax category of the subset of tax categories, determine an entropy of the posterior probability distribution, determine a variance of the posterior probability distribution, and calculate a respective combined confidence score for each tax category of the subset of tax categories by combining the posterior probability distribution, the entropy of the posterior probability distribution, and the variance of the posterior probability distribution. The processing circuitry receives an output pair from the calibration and probabilistic classification module. The output pair is comprised of a predicted tax category and its respective combined confidence score. Based on the combined confidence score for the predicted tax category, the processing circuitry outputs a final tax category for the product.

According to another aspect, a method for probabilistically classifying tax categories is provided. The method includes receiving a query to determine a tax category for a product, the query including product information related to the product and sending a prompt to a tax category prediction language model. The prompt includes the product information and instructs the tax category prediction language to predict a tax category for the product based on the product information. The method further includes receiving, as output from the tax category prediction language model, a subset of tax categories of a plurality of tax categories with respect to a tax category classification of the product, and respective probability scores for each tax category of the subset of tax categories. The method further includes implementing a calibration and probabilistic classification module to calibrate the respective probability scores output by the tax category prediction language model. The respective probability scores are calibrated by generating a posterior probability distribution by incorporating historical accuracy data for each tax category of the subset of tax categories, determining an entropy of the posterior probability distribution, determining a variance of the posterior probability distribution, and calculating a respective combined confidence score for each tax category of the subset of tax categories by combining the posterior probability distribution, the entropy of the posterior probability distribution, and the variance of the posterior probability distribution. The method further includes receiving an output pair from the calibration and probabilistic classification module, the output pair comprising a predicted tax category and its respective combined confidence score. Based on the combined confidence score for the predicted tax category, the method includes outputting a final tax category for the product.

According to another aspect, a computing system for probabilistic classification of tax categories is provided. The computing system includes processing circuitry configured to execute instructions using portions of associated memory to implement a probabilistic tax category classification program. The processing circuitry is configured to receive a query to determine a tax category for a product. The query includes product information related to the product. The processing circuitry is further configured to implement a product data enrichment module to perform multi-source data aggregation and semantic enrichment on product descriptions. The processing circuitry is further configured to implement a prompt engineering and language model reasoning module to group the product with other products and generate a context-rich prompt based on the product grouping. The products are grouped based on features identified during semantic enrichment of the product descriptions. The processing circuitry is further configured to send the prompt to a tax category prediction language model. The prompt includes the product information and instructs the tax category prediction language model to predict a tax category for the product based on the product information. The processing circuitry receives, as output from the tax category prediction language model, a subset of tax categories of a plurality of tax categories with respect to a tax category classification of the product, and respective probability scores for each tax category of the subset of tax categories. A calibration and probabilistic classification module is implemented to calibrate the respective probability scores output by the tax category prediction language model. The calibration and probabilistic classification module is configured to generate a posterior probability distribution via Bayesian inference by incorporating historical accuracy data for each tax category of the subset of tax categories, determine an entropy of the posterior probability distribution, determine a variance of the posterior probability distribution via Monte Carlo dropout, and calculate a respective combined confidence score for each tax category of the subset of tax categories by combining the posterior probability distribution, of the posterior probability distribution, and the variance of the posterior probability distribution. The processing circuitry receives an output pair from the calibration and probabilistic classification module. The output pair is comprised of a predicted tax category and its respective combined confidence score. The respective combined confidence score for the predicted tax category is a highest combined confidence score among the respective combined confidence scores. Based on the combined confidence score for the predicted tax category, the processing circuitry outputs a final tax category for the product.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of a computing system for implementing a probabilistic tax category classification program, according to an embodiment of the present disclosure.

FIGS. 2 and 3 show schematic views of components included in the probabilistic tax category classification program implemented by the computing system of FIG. 1.

FIG. 4 shows a flowchart for a method for probabilistically classifying tax categories, according to one example of the present disclosure.

FIG. 5 shows a schematic view of an example computing environment in which the computer device of FIG. 1 may be enacted.

### DETAILED DESCRIPTION

The classification of customer products into tax categories is a fundamental capability of enterprise tax management platforms that automate and digitize myriad tax-related processes, thereby ensuring consistency, accuracy, and global compliance with tax laws. Traditional classification approaches have often relied on manually crafted rules or supervised machine learning techniques using static datasets. The solution described herein present a novel approach for managing accuracy and confidence levels related to tax category classification of customer products. The predictive capabilities of generative large language models and probabilistic calibration techniques are leveraged to improve the accuracy, confidence, and reliability of tax category classification.

The proposed methodology applies the strengths of modern natural language processing (NLP) techniques with classical statistical and mathematical methods to provide a robust, scalable solution. The integration of ground truth, accuracy, confidence levels, and calibration techniques is central to the development and deployment of a reliable tax category classification system using generative large language models (LLMs). Reliability and trust of confidence levels are enhanced by combining the predictive power of generative LLMs with multiple calibration techniques to leverage historical classification accuracy along with a probabilistic framework.

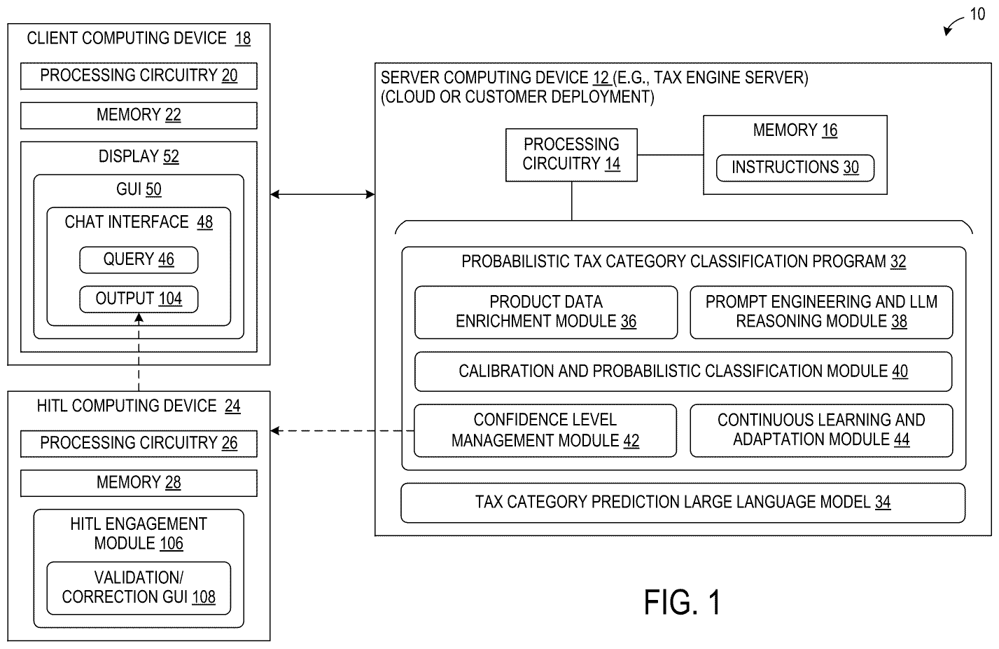

The following discussion provides an overview of the theoretical foundations, probabilistic reasoning, and mathematical underpinnings of the system and offer a comprehensive understanding of how these components interact to support accurate classification results with high levels of confidence. These sections are followed by a detailed description of example embodiments of systems and methods for a probabilistic approach to classifying products into tax categories using generative LLMs and calibration techniques, with reference to FIGS. 1-5.

### Ground Truth

In the lifecycle of a tax category classification solution using an LLM, ground truth plays a fundamental role in establishing fidelity and refining confidence levels through calibration techniques. Ground truth guides the initial training and prompt engineering strategies, ensuring that the LLM achieves a high level of accuracy. This accuracy then informs the calibration techniques used during inference. By maintaining a continuous feedback loop between these elements, the system can deliver robust and reliable predictions, with each tax category classification backed by a well-calibrated confidence level that represents the model's historical accuracy data as validated by ground truth data. The result is a solution where each classification prediction is backed by a specific, calculated, and defensible confidence level that accurately reflects the model's historical performance, as determined by the ground truth. This integration of ground truth and calibration of confidence levels throughout the lifecycle ensures that the solution remains robust, trustworthy, and effective across tax platform applications.

### Calibration Techniques

As the system transitions from the training phase to the operational inference phase, the calibration techniques are used to align the confidence levels with the actual likelihood of accuracy. For example, once prompt engineering strategies have been tested and the model is deployed in production, the accuracy observed during training informs the calibration process. Techniques such as Platt scaling, isotonic regression, and Bayesian inference leverage this accuracy to adjust the confidence levels of the predictions.

In an operational production phase, this calibrated confidence level is critical for driving acceptance of tax category classification, workflow, and human-in-the-loop (HITL) intervention with decision-making to manage edge cases and exception conditions. Therefore, the continuous feedback loop between ground truth, accuracy, confidence level, and calibration is advantageous. HITL engagement plays a fundamental role, particularly when dealing with edge cases or when the model's confidence level is low. When the model's confidence in a prediction does not meet a certain threshold-often due to high entropy (e.g., randomness, uncertainty) or poor calibration-human review is triggered. This is directly related to the calibration process: well-calibrated models help determine the appropriate confidence thresholds for human intervention. During these HITL interactions, ground truth is established or confirmed by human experts, which then feeds back into the system, improving both accuracy and calibration over time. This iterative process not only enhances system performance by providing more accurate ground truth testing data, but also ensures that confidence levels remain aligned with real-world outcomes, thereby refining future predictions and reducing the need for manual intervention as the solution matures.

Calibration techniques and methods can help align the model's confidence scores with its actual output accuracy, thereby increasing the trustworthiness and practical utility of its predictions in tax category classification tasks. Table 1, shown below, lists common calibration techniques. As shown, each technique has strengths (“pros”) and limitations (“cons”), and the choice of calibration may be informed by the specific requirements and constraints of the deployment environment.

TABLE 1

| Calibration method | Pros | Cons |
|---|---|---|
| Bayesian inference | Incorporates prior knowledge | Requires a well-defined prior |
| | into predictions | distribution |
| | Can adjust predictions based | Can be computationally |
| | on external data (e.g., | complex |
| | integrated with other | May require expertise in |
| | calibration techniques) | Bayesian methods |
| | Provides a principled way to | |
| | handle uncertainty | |
| Entropy-based | Simple to calculate | Does not change output, only |
| uncertainty | Provides a direct measure of | measures uncertainty |
| | uncertainty without modifying | May not fully capture |
| | the LLM | complex uncertainty scenarios |
| Isotonic regression | Flexible, nonparametric | Prone to overfitting, |
| | Can handle various data | especially with small datasets |
| | distributions | Computationally more |
| | Effective for complex | intensive |
| | calibration tasks | |
| Monte Carlo dropout | Can estimate uncertainty by | Increases computational cost |
| | simulating multiple | due to multiple inferences |
| | predictions | Less effective than true Monte |
| | Useful when direct dropout is | Carlo dropout |
| | not possible | |
| Platt scaling (on | Effective in improving | Requires separate calibration |
| logprobs) | calibration in binary class | model and increased |
| | settings | computing |
| | Works well with a labeled | Requires labeled data |
| | validation set | Limited in effectiveness if |
| | | only applied to logprobs |
| | | instead of logits |
| | | Less effective in multi-class |
| | | problems |
| Temperature scaling | No need for retraining LLM | Traditional scaling not |
| | If softmax temperature | supported without softmax |
| | parameter exists, can | temperature parameter or |
| | indirectly apply to logits and | direct access to logits |
| | adjust the LLM confidence | Requires careful tuning when |
| | score | using with softmax |
| | If no softmax temperature | temperature parameter for |
| | parameter exists but direct | LLM inference |
| | access to logits, can modulate | If only softmax or logprob |
| | logits before softmax to adjust | output available, then no |
| | LLM confidence score | logits manipulation by |
| | | temperature possible |

### Probabilistic and Theoretical Foundation

Generative LLMs are designed to generate human-like text by predicting the next word or sequence of words in a given context. These models are trained on vast corpora of text data, enabling them to understand and generate text across a wide range of topics. In the context of tax category classification, LLMs can be prompted to classify a customer product into a tax category (i.e., labeled data with annotations) based on information, such as textual descriptions and enrichment data, associated with the product. The product classification task is approached from a probabilistic perspective, combining LLM outputs with Bayesian inference to derive final classification probabilities (i.e., confidence levels).

### Generative Large Language Models and Probabilistic Output

A key feature of LLMs is ability to assign probabilities to different possible outputs based on input features (e.g., product description and enrichment data). This is typically achieved through a softmax function applied to log-odds units, i.e., logits, which are the unnormalized probability predictions produced by the neural network.

Softmax classification is a method used at the output layer of LLMs to generate predictions. In accordance with the objective of classifying a product into a tax category, a plurality of tax categories are considered, and a subset of the plurality of tax categories is identified as predicted tax categories for the classification of the product. Logits scores (pre-softmax values) for each tax category in the subset of identified tax categories are output and passed through a softmax function to convert them into probabilities that sum to one, with the respective probabilities representing the likelihood of each tax category being the correct tax category for the classification of the product. The LLM returns a probability distribution for the subset of tax categories for the product according to the following Equation (1):

$$P ( {tc}_{i} \vert product ) = softmax ( {z}_{i} ) \qquad ( 1 )$$

where TC is the set of possible tax categories {tc₁, tc₂, . . . , tcₙ} and zᵢ are the logits (output of the model as unnormalized log probabilities before applying activation function like softmax) produced by the model for each tax category tcᵢ. The softmax function is mathematically defined as shown in Equation (2):

$$softmax ( {z}_{i} ) = \frac{{e}^{{z}_{i}}}{{\sum }_{j = 1}^{n} {e}^{{z}_{j}}} \qquad ( 2 )$$

The denominator ensures that the outputs sum to 1, forming a valid probability distribution. The output provides the initial likelihood for each tax category.

### Softmax Temperature Scaling

With softmax probabilities serving as the exponential normalization of the logit values converted into a probability distribution across the possible outputs, they are directly interpretable as confidence scores across the predicted tax categories, making them suitable for temperature scaling. The formula for softmax with temperature scaling is shown below as Equation (3):

$$softmax ( {z}_{i} ) = \frac{{e}^{{z}_{i}} / T}{{\sum }_{j} {e}^{{z}_{j} / T}} \qquad ( 3 )$$

where T is the temperature, zᵢ are the logits, and i and j index over the classes.

Temperature scaling is used to calibrate the relative confidence scores of the predictions output by the model, particularly to make the softmax outputs better reflect true probabilities. The process involves finding an optimal temperature parameter using a validation set, then applying this parameter to the logits before computing softmax probability. The temperature is meant to adjust the sharpness or softness of the probability distribution, i.e., adjust the confidence of the predictions, to improve the alignment between confidence and accuracy.

Lowering T sharpens the distribution, thereby resulting in the predictions becoming more deterministic, meaning the model will be more confident in the highest probability outcome. For example, lowering temperature <1 makes the model more confident.

Raising T softens (flattens) the distribution resulting in the predictions becoming more random, meaning the model will be less confident. This allows the model to explore a wider range of possible outputs. For example, increasing temperature >1 will make the model's predictions more diverse, spreading the probabilities more evenly among the possible classes.

In practice, setting the temperature to 0.0 makes the model very conservative, choosing the highest probability outcome with little variation. A temperature of 1.0 leaves the probabilities unchanged.

With an LLM, the softmax function typically includes a temperature parameter. The direct modulation of the temperature parameter enables recalibration of the probabilities, i.e., the softmax outputs, which can be interpreted as probabilities, with the aim to align them more closely with the actual accuracies.

### Bayesian Inference

Bayesian classification involves using Bayesian inference to update the probability estimate for each tax category as more data becomes available. It starts with a prior distribution over the tax categories, which gets updated into a posterior distribution in light of the data processed by the LLM. This is particularly useful in scenarios when there is some prior knowledge about the categories or when data arrives incrementally.

Bayesian inference is applied to refine the LLM predictions. It is a powerful statistical method that updates the probability of a hypothesis as more evidence or information becomes available. It is rooted in Bayes' theorem, with the Bayesian formula expressed as the following Equation (4):

$$P ( H \vert E ) = \frac{P ( E \vert H ) \cdot P ( H )}{P ( E )} \qquad ( 4 )$$

Where P(H|E) is the posterior probability of the hypothesis H given the evidence E. In other words, the posterior probability represents the final refined probability for each tax category, where H represents tax category tcᵢ and E represents the model's softmax output for a given input and historical accuracy for tax category tcᵢ. P(E|H) is the likelihood given the input (derived from model's softmax output), which represents the probability of observing the evidence E, assuming that the hypothesis H representing the tax category tcᵢ is true. P(H) is the prior probability of the hypothesis H before considering the evidence E. The prior probability of H is calculated based on past classification results, for example, the normalized historical accuracy for tax category tcᵢ. P(E) is the marginal likelihood, or the total probability of the evidence under all possible hypotheses, including all priors and likelihoods, normalized to ensure the posterior probabilities sum to 1.

Bayesian inference allows the integration of prior knowledge with new, posterior LLM prediction data, which yields more refined and robust predictions. This is particularly useful in cases when the model's initial predictions might be uncertain or biased.

Combining Generative LLMs with Bayesian Inference

The approach disclosed herein integrates the softmax outputs from a generative LLM with Bayesian inference to refine tax category classification. The process involves the following steps:

1. Generate Initial Predictions: The LLM is prompted to classify a customer product into one of several tax categories based on a provided product description and enrichment data. The model outputs a probability distribution over the tax categories.

2. Apply Bayesian inference: The initial probabilities are treated as likelihoods. These are combined with prior probabilities, which are derived from historical data or expert knowledge about tax category distributions. Bayes' theorem is then used to update these probabilities, yielding a posterior distribution that reflects both the model's predictions and prior knowledge.

3. Interpret Results: The posterior probabilities provide a more reliable and interpretable classification, indicating not only the most likely tax category but also the confidence in this classification.

### Entropy as a Measure of Uncertainty

Entropy-based methods involve using the entropy of the prediction probabilities as a measure of uncertainty, randomness, or confidence of a probability distribution. High entropy suggests that the model is uncertain about its predictions, indicating cases where the input might not clearly belong to any of the known categories or might require human intervention.

In the context of tax category classification, entropy can quantify the uncertainty of the predictions output by the LLM and Bayesian inference posterior probabilities for the predicted tax categories using the following Equation (5):

$$H ( P ) = - {\sum }_{i = 1}^{n} P ( t {c}_{i} ) log P ( t {c}_{i} ) \qquad ( 5 )$$

where H is the entropy of the probability distribution P over the tax categories {tc₁, tc₂, . . . , tcₙ} and P(tcᵢ) denotes the probability of the occurrence of event i. Low entropy indicates a higher confidence level of the classification predictions, while high entropy suggests uncertainty regarding the classification, as the probability mass is distributed more evenly across possible tax categories. This metric is critical in evaluating the reliability of the tax category predictions output by the LLM.

Determining whether an entropy value is low or high generally depends on the context of the probability distribution being measured.

1. Minimum Entropy (0 bits): Entropy is zero when the probability of one outcome is 1 (i.e., certainty) and 0 for all others. This means there is no uncertainty.

2. Maximum Entropy: This occurs when all outcomes are equally likely. For a distribution with n tax categories, the maximum entropy is reached when each category has a probability of 1/n. The entropy formula for maximum entropy is shown by the following Equation (6):

$${H}_{max} = {log}_{2} n \qquad ( 6 )$$

where H is the entropy over n tax categories. By incorporating entropy into the Bayesian framework, the influence of the prior probabilities can be adjusted based on the confidence of the model's predictions and posterior probabilities. This adjustment leads to more nuanced and context-sensitive tax category classification outcomes.

### Monte Carlo Dropout for Uncertainty Estimation

Monte Carlo dropout is a technique primarily used to estimate and measure uncertainty in neural network predictions. During inference, dropout layers in the model are activated (i.e., random fraction of network neurons are “dropped out” or temporarily removed from the network). The dropout forces the remaining network to learn more features that are not dependent on specific neurons.

By enabling dropout during inference and performing multiple stochastic forward passes through the model with dropout, a distribution of predictions can be obtained. The mean and variance across these distributions are then determined. The variances of distributions provide a measure of uncertainty for each input (i.e., tax category), which can be incorporated into the Bayesian update process. This calculation contributed to assessing the confidence of the model in its predictions, as well as the probabilistic categorization of the predictions. The mean can be determined using the following Equation (7):

$${P}_{MC} ( {tc}_{i} ) = \frac{1}{M} {\sum }_{m = 1}^{M} {P}_{m} ( {tc}_{i} ) \qquad ( 7 )$$

where M is the number of Monte Carlo passes, and Pₘ(tcᵢ) be the probability assigned to tax category tcᵢ in the m-th pass. The mean typically represents the final (central) prediction, and a consistent mean across multiple Monte Carlo simulations suggests model predictions are stable.

Variance (or its square root, standard deviation) measures the spread of the predictions around the mean. It quantifies how much individual predictions deviate from the average prediction and the overall confidence in that prediction. Variance can be determined by the following Equation (8):

$${σ}^{2} ( {tc}_{i} ) = \frac{1}{M} {\sum }_{m = 1}^{M} {( {P}_{m} ( {tc}_{i} ) - {P}_{MC} ( t {c}_{i} ) )}^{2} \qquad ( 8 )$$

Standard deviation can be determined by the following Equation (9):

$$σ ( {tc}_{i} ) = \sqrt{\frac{1}{M} {\sum }_{m = 1}^{M} {( {P}_{m} ( {tc}_{i} ) - {P}_{MC} ( {tc}_{i} ) )}^{2}} \qquad ( 9 )$$

The terms “Low” and “High” can seem subjective without context or a threshold. If required, a number of approaches can be applied to establish more objective criteria (e.g., relative measures using percentiles against a distribution, absolute thresholds based on domain knowledge, normalization using Z-scores across predictions, model calibration techniques, experimentation). Low variance (or standard deviation) indicates that individual predictions are close to, or clustered around, the mean, suggesting the model is confident in its predictions. There is less uncertainty because the model produces similar results even when some neurons are “dropped out” during inference. High variance (or standard deviation) indicates predictions are spread out, suggesting the model is less certain about its predictions. High variance means the model's output is more sensitive to changes in input due to dropout, reflecting higher uncertainty and low confidence.

With variance, there is an additional measure of uncertainty that complements the entropy metric. The variance can be used to adjust the weight given to the model's predictions in the Bayesian update, further refining the posterior probabilities.

### Calculating Combined Confidence Score

Using Bayesian inference in combination with entropy-based methods and Monte Carlo dropout to categorize text-based data with LLMs, a combined confidence (CC) score for predicting category classification can be calculated, as shown in the following Equation (10):

$$CC = P \times ( 1 - NE ) \times ( 1 / ( 1 + Mean ( SD ) ) \qquad ( 10 )$$

where posterior (P) is the base confidence from Bayesian inference, normalized entropy (NE) adjusts the confidence based on uncertainty in the probability distribution, and the standard deviation (SD) inversely scales confidence based on prediction variance.

The system disclosed herein offers a comprehensive approach to assessing and interpreting the confidence in tax category classifications of customer products. The multi-faceted confidence score enhances the reliability and interpretability of the model's predictions, enabling more informed decision-making based on the classification results.

Augmented by thresholding on probabilities in cases in which high confidence in categorization is required, a probability threshold for determining tax category classification can be set. If the highest probability is below the threshold, the input can be flagged for review by a human via a human-in-the-loop protocol, or placed in an “uncertain” category for subsequent review.

The integration of Bayesian inference with the generative capabilities of an LLM offers significant advantages in terms of robustness and interpretability. By leveraging prior knowledge and adjusting for uncertainty, the described approach mitigates overfitting to specific instances or noise in the data. The resulting posterior probabilities provide a clear indication of both the most likely tax category and the confidence in the tax category classification, which is accurately assessing the correct tax on a product and avoiding potential legal issues

### Example Embodiment

In accordance with principles discussed above, a specific example embodiment of a computing system 10 for probabilistic classification of tax categories according to the present disclosure will now be described, with reference to FIGS. 1-5.

Referring initially to FIG. 1, the computing system 10 includes at least one computing device. The computing system 10 is illustrated as having a first computing device 12 including processing circuitry 14 and memory 16, a second computing device 18 including processing circuitry 20 and memory 22, and a third computing device 24 including processing circuitry 26 and memory 28. The illustrated implementation is exemplary in nature, and other configurations are possible. In the description below, the first computing device will be described as a server 12, the second computing device will be described as a client computing device 18, and the third computing device will be described as a human-in-the-loop (HITL) computing device 24. The server 12, the client computing device 18, and the HITL computing device 24 are in communication via a network, and respective functions carried out at each computing device 12, 18, 24 will be described. It will be appreciated that in other configurations, the computing system 10 may include a single computing device that carries out the salient functions of the first computing device 12, the second computing device 18, and/or the third computing device 24, the first computing device 12 could be a computing device other than server, the second computing device 18 could be a computing device other than a client computing device, and the third computing device 24 could be a computing device other than an HITL computing device. In other alternative configurations, functions described as being carried out at the first computing device 12 may alternatively be carried out at the second computing device 18 and/or the third computing device 24 and vice versa.

Continuing with FIG. 1, the processing circuitry 14 is configured to execute instructions 30 using portions of associated memory 16 to implement a probabilistic tax category classification program 32. It will be appreciated that distributed processing strategies may be implemented to execute the probabilistic tax category classification program 32 described herein, and the processing circuitry 14 therefore may include multiple processing devices, such as cores of a central processing unit, co-processors, graphics processing units, field programmable gate arrays (FPGA) accelerators, tensor processing units, etc., and these multiple processing devices may be positioned within one or more computing devices, such as the client computing device 18 and the HITL computing device 24, and may be connected by an interconnect (when within the same device) or via a packet switched network links (when in multiple computing devices), for example.

The probabilistic tax category classification program 32 is implemented to interface with a tax category prediction language model 34, which may be a generative pre-trained transformer model, such as Chat-GPT 4, LLAMA, or the like. In some examples, the model can be a multi-modal model configured to accept text, images, and/or audio as forms of input and configured to generate text, images, and/or audio as output. In the remainder of the disclosure, the tax category prediction language model 34 will be referred to as the tax category prediction LLM 34.

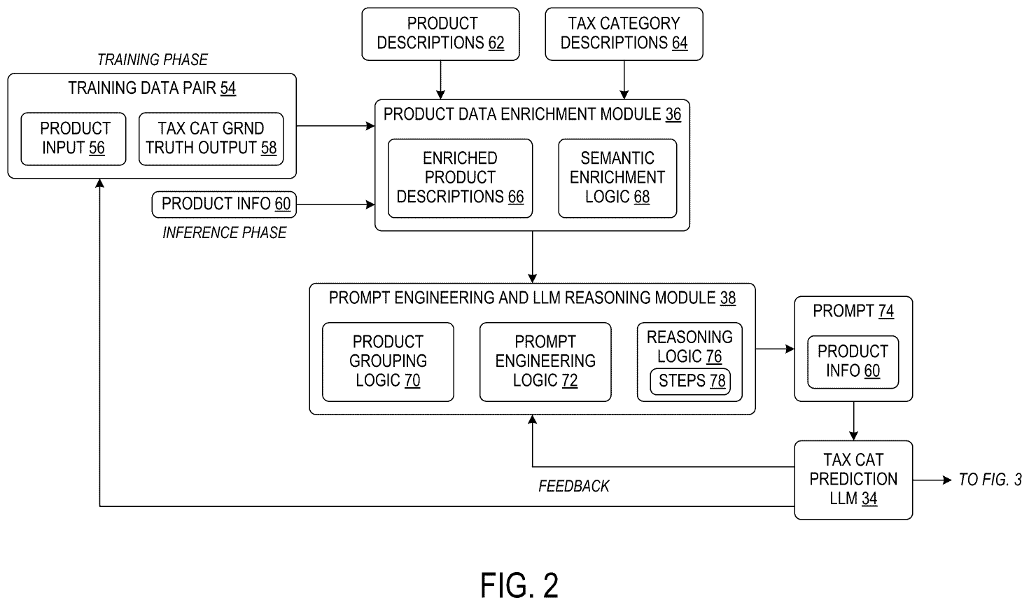

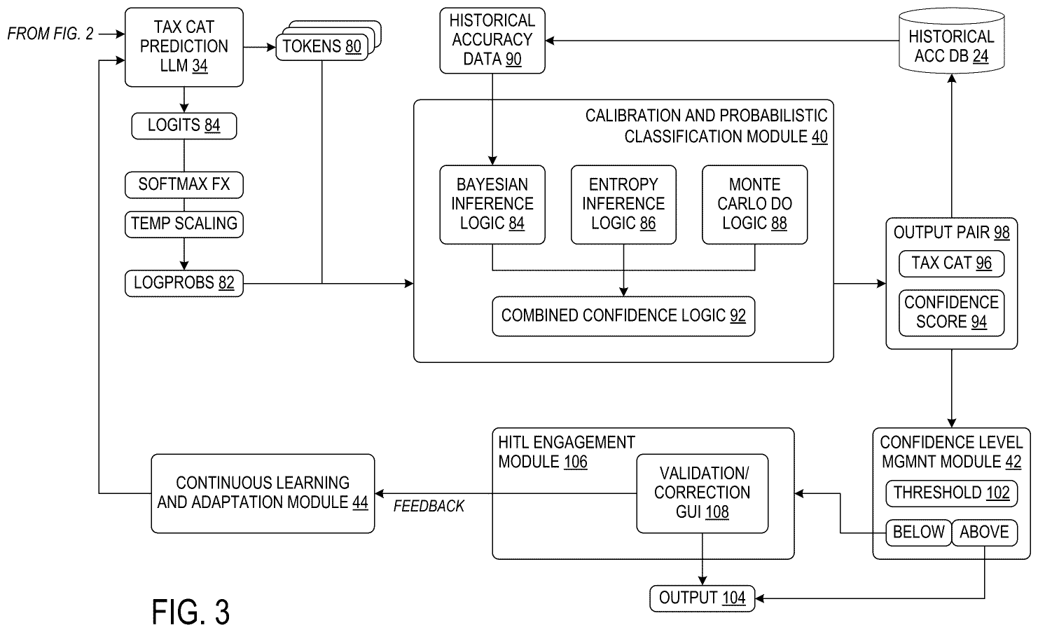

In accordance with the features and capabilities of the computing system 10 discussed above, the probabilistic tax category classification program 32 includes a product data enrichment module 36, a prompt engineering and LLM reasoning module 38, a calibration and probabilistic classification module 40, a confidence level management module 42, and a continuous learning and adaptation module 44. These components and interactions therebetween will be discussed in detail below with reference to FIGS. 2 and 3.

As shown in FIG. 1, the processing circuitry 14 is configured to receive a query 46 to determine a tax category for a product. It will be appreciated that the term “product” as used herein may be one of tangible and intangible products and service offerings, e.g., both goods and services that may be subject to transaction taxes, such as sales and use tax, lodging and occupancy tax, and the like. It will be further appreciated that a tax category is a parameter that represents groupings of items with like taxation.

The query 46 may be input by a user during dialog session with the tax category prediction LLM 34 via a chat interface 48, which may be displayed in a graphical user interface (GUI) 50 on a display 52 of the client computing device 18. The query 46 includes information related to the product, such as a product name, product description, product image, or the like.

Turning to FIG. 2, the information related to the product is input to the product data enrichment module 36, which is implemented by the processing circuitry 14. In a training phase, the information related to the product is included in a training data pair 54, which is comprised of product information input 56 and tax category ground truth output 58. In an inference phase, the information related to the product is configured as product information 60.

The product data enrichment module 36 is configured to collect product descriptions 64 via multiple web searches and third-party services, and receive input of tax category descriptions 64. The product data enrichment module 36 performs multi-source data aggregation to enrich the product descriptions 62 with comprehensive data obtained the multiple sources. The enriched product descriptions 66 are used to logically group the product in question with other products based on shared features or attributes included in the product information 60. Additionally, semantic enrichment logic 68 included in the product data enrichment module 36 is implemented to analyze the enriched product descriptions 66 to identify distinguishing features that are used to group products according to tax category, as discussed in detail below.

The prompt engineering and LLM reasoning module 38 is configured to ingest information from the data enrichment module 36, including the tax category descriptions 64, the enriched product descriptions 66, and features identified by the semantic enrichment logic 68. The distinguishing features identified by the semantic enrichment logic 68 may include details regarding product usage, physical characteristics, material composition, and regional specifics that may influence tax obligations, for example. Product grouping logic 70 is applied to these features to logically group the products, thereby forming the basis for subsequent reasoning-based tax categorization. The prompt engineering and LLM reasoning module 38 applies prompt engineering logic 72 to construct a context-rich prompt 74 based on the logical product grouping that includes tax-relevant features and scenarios. As such, the prompt 74 is specifically engineered to influence the classification of the product to a tax category and guide the tax category prediction LLM 34 in its reasoning process. Reasoning logic 76 is configured to record logical steps 78 in each reasoning process for constructing the prompt 74, thereby providing explanations for the logic that led to each conclusion and ensuring replicability of the reasoning process.

Upon completion of the prompt engineering process, the processing circuitry 14 is configured to send the prompt 74, and the product information 60, to the tax category prediction LLM 34, and instruct the tax category prediction LLM 34 to predict a tax category for the product based on the product information 60 and the context included in the prompt 74.

Continuing to FIG. 3, the processing circuitry 14 receives, as output from the tax category prediction LLM 34, a subset of tax categories of a plurality of tax categories with respect to a tax category classification of the product, and respective probability scores for each tax category of the subset of tax categories. It will be appreciated that each tax category output is represented by an output token 80, and the respective probability scores are logarithms of probabilities (logprobs) 82 of log-odds units (logits) 84, to which temperature scaling and the softmax function has been applied, for each tax category output token 80.

As discussed in detail above, the probability scores that are output during an inference phase are calibrated to align the model's confidence scores with its actual output accuracy in predicting a tax category classification for a product. To this end, the processing circuitry 14 is configured to implement the calibration and probabilistic classification module 40 to calibrate the respective logprobs 82 output by the tax category prediction LLM 34. The calibration and probabilistic classification module 40 includes Bayesian inference logic 84, entropy inference logic 86, and Monte Carlo dropout logic 88.

In a first phase of calibrating the respective logprobs 82 output by the tax category prediction LLM 34, a posterior probability distribution is generated by incorporating historical accuracy data 90 for each tax category of the subset of tax categories. In the embodiment described herein and shown in FIG. 3, Bayesian inference logic 84 is applied to the respective logprobs 82 to generate the posterior probability distribution. The historical accuracy data 90 is acquired from prior predicted tax category and combined confidence score pairs output by the calibration and probabilistic classification module 40, and from ground truth testing during a training phase. Next, entropy inference logic 86 is applied to determine an entropy of the posterior probability distribution. A variance of the posterior probability distribution is determined by applying Monte Carlo dropout logic 88. The posterior probability distribution, the entropy of the posterior probability distribution, and the variance of the posterior probability distribution are combined by applying combined confidence logic 92 to calculate a respective combined confidence score for each tax category of the subset of tax categories. Once the combined confidence score for each tax category is calculated, the combined confidence logic 92 determines a highest combined confidence score 94, and the predicted tax category 96 associated with the highest combined confidence score and the highest combined confidence score 94 are output from the calibration and probabilistic classification module 40 as an output pair 98. The output pair 98 is stored in a historical accuracy database 100 for use as historical accuracy data 90 in subsequent applications of Bayesian inference logic 84.

The processing circuitry 14 is configured to receive the output pair 94 of the predicted tax category 96 and its respective combined confidence score 94 from the calibration and probabilistic classification module 40, and input the output pair 94 to the confidence level management module 42. The confidence level management module 42 includes a predetermined threshold value 102. As described above, a confidence threshold may be established to determine whether human tax expert intervention is needed to review the predicted tax category 96. When the confidence level management module 42 determines the combined confidence score 94 for the predicted tax category 96 is above the predetermined threshold value 102, the processing circuitry 14 is configured to confirm the predicted tax category 96 as the final tax category, which may be displayed as output 104 in the chat interface of the client computing device 18, as shown in FIG. 1.

Conversely, when the combined confidence score 94 for the predicted tax category 96 is below the predetermined threshold value 102, the processing circuitry 14 is configured to implement a human-in-the-loop engagement module 106 in the HITL computing device 24, discussed above and shown in FIG. 1, to trigger human review of the predicted tax category 96 prior to its output as the final tax category 104. The HITL engagement module 106 includes a validation/correction GUI 108 by which a human tax expert can validate or correct the predicted tax category 96. As described above with reference to FIG. 1, the probabilistic tax category classification program 32 includes a continuous learning and adaptation module 44. As shown in FIG. 3, feedback from the HITL engagement module 106 may be sent to the continuous learning and adaptation module 44, where it is processed and used by the tax category prediction LLM 34 to inform the calibration techniques used during inference, as well as other elements in the system.

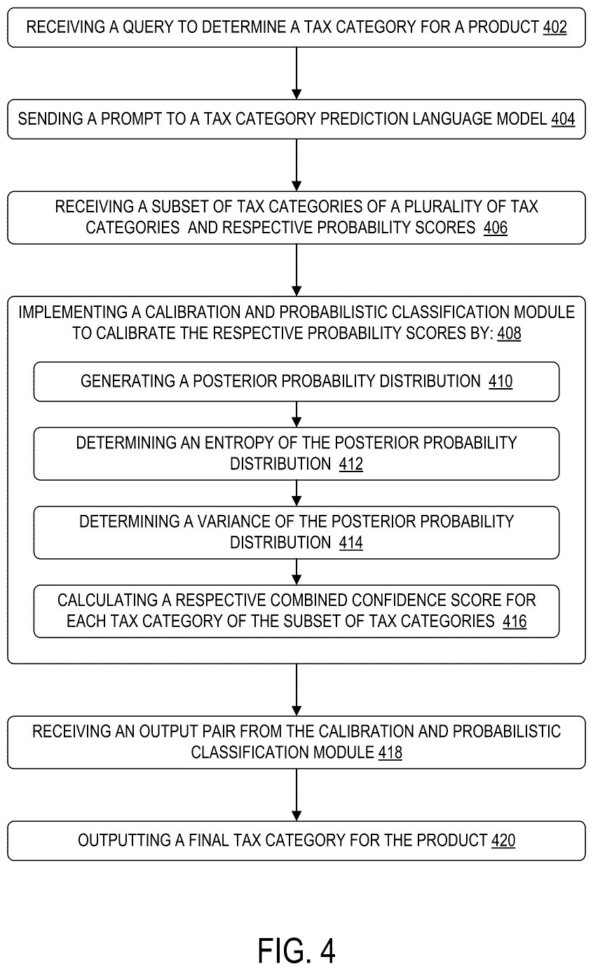

FIG. 4 shows a flowchart for a method 400 for probabilistically classifying tax categories. The method 400 may be implemented by the computing system 10 illustrated in FIG. 1, or via other suitable hardware and software.

At step 402, the method 400 may include receiving a query to determine a tax category for a product. As discussed above, the query includes product information related to the product, which may be grouped with other products based on shared features or attributes, as determined by enriched product descriptions and semantic enrichment logic.

Continuing from step 402 to step 404, the method 400 may include sending a prompt to a tax category prediction language model. The prompt includes the product information and instructs the tax category prediction language to predict a tax category for the product based on the product information. A context-rich prompt specifically engineered to influence the classification of the product to a tax category and guide the tax category prediction LLM by applying prompt engineering logic to the product grouping.

Proceeding from step 404 to step 406, the method 400 may include receiving a subset of tax categories of a plurality of tax categories and respective probability scores for each tax category of the subset of tax categories as output from the tax category prediction language model, with respect to a tax category classification of the product. As discussed in detail above, each tax category output may be represented by an output token, and the respective probability scores are logprobs.

Advancing from step 406 to step 408, the method 400 may include implementing a calibration and probabilistic classification module to calibrate the respective probability scores output by the tax category prediction language model by executing steps 410 to 416 of the method 400.

At step 410, the method 400 may include generating a posterior probability distribution by incorporating historical accuracy data for each tax category of the subset of tax categories. The posterior probability distribution may be generated via Bayesian inference. At step 412, the method 400 may include determining an entropy of the posterior probability distribution. At step 414, the method 400 may include determining a variance of the posterior probability distribution. The variance of the posterior probability distribution may be determined via Monte Carlo dropout. At step 416, the method 400 may include calculating a respective combined confidence score for each tax category of the subset of tax categories. The posterior probability distribution, the entropy of the posterior probability distribution, and the variance of the posterior probability distribution may be combined by applying combined confidence logic to calculate a respective combined confidence score for each tax category.

Continuing from step 416 to step 418, the method 400 may include receiving an output pair from the calibration and probabilistic classification module. The output pair includes a predicted tax category and its respective combined confidence score. The combined confidence score may be the highest combined confidence score, as determined by the calibration and probabilistic classification module. The output pair may be stored in a historical accuracy database as historical accuracy data for subsequent generations of a posterior probability distribution.

Proceeding from step 418 to step 420, the method 400 may include outputting a final tax category for the product based on the combined confidence score for the predicted tax category. As discussed above, when the combined confidence score for the predicted tax category is above a predetermined threshold value, the processing circuitry is configured to confirm the predicted tax category as the final tax category, and, when the combined confidence score for the predicted tax category is below a predetermined threshold value, the processing circuitry is configured to implement a human-in-the-loop engagement module to trigger human review of the predicted tax category prior to output of the final tax category.

This disclosure presents a probabilistic approach to tax category classification that combines the predictive power of large language models with the rigor of Bayesian inference. The framework described herein is highly scalable and can be adapted to different classification tasks beyond tax categories. The use of Bayesian inference allows for the incorporation of diverse types of prior knowledge, making the approach flexible and extensible to various domains while improving classification confidence and reliability.

In some embodiments, the methods and processes described herein may be tied to a computing system of one or more computing devices. In particular, such methods and processes may be implemented as a computer-application program or service, an application-programming interface (API), a library, and/or other computer-program products.

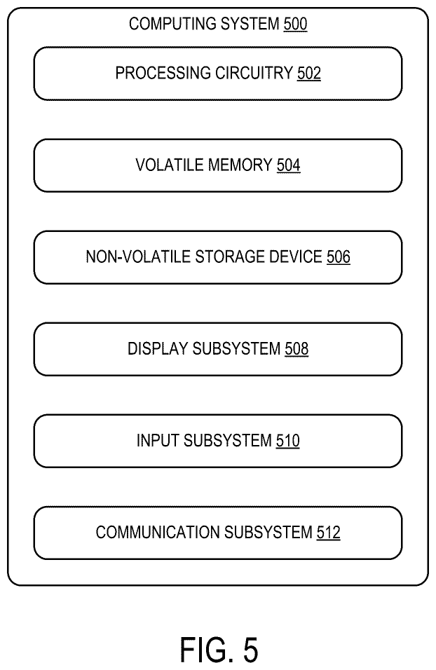

FIG. 5 schematically shows a non-limiting embodiment of a computing system 500 that can enact one or more of the methods and processes described above. Computing system 500 is shown in simplified form. Computing system 500 may embody the computing system 10 described above and illustrated in FIG. 1. Components of computing system 500 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 500 includes processing circuitry 502, volatile memory 504, and non-volatile storage device 506. Computing system 500 may optionally include a display subsystem 508, input subsystem 510, communication subsystem 512, and/or other components not shown in FIG. 5.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of processing circuitry 502 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 502.

Non-volatile storage device 506 includes one or more physical devices configured to hold instructions executable by the processing circuitry to implement the methods and processes described herein. When such methods and processes are implemented, the state of non-volatile storage device 506 may be transformed—e.g., to hold different data.

Non-volatile storage device 506 may include physical devices that are removable and/or built in. Non-volatile storage device 506 may include optical memory, semiconductor memory, and/or magnetic memory, or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to non-volatile storage device 506.

Volatile memory 504 may include physical devices that include random access memory. Volatile memory 504 is typically utilized by processing circuitry 502 to temporarily store information during processing of software instructions. It will be appreciated that volatile memory 504 typically does not continue to store instructions when power is cut to volatile memory 504.

Aspects of processing circuitry 502, volatile memory 504, and non-volatile storage device 506 may be integrated together into one or more hardware-logic components. Such hardware-logic components may include field-programmable gate arrays (FPGAs), program- and application-specific integrated circuits (PASIC/ASICS), program- and application-specific standard products (PSSP/ASSPs), system-on-a-chip (SOC), and complex programmable logic devices (CPLDs), for example.

The terms “agent,” “module,” “program,” and “engine” may be used to describe an aspect of computing system 500 typically implemented in software by a processor to perform a particular function using portions of volatile memory, which function involves transformative processing that specially configures the processor to perform the function. Thus, an agent, module, program, or engine may be instantiated via processing circuitry 502 executing instructions held by non-volatile storage device 506, using portions of volatile memory 504. It will be understood that different agents, modules, programs, and/or engines may be instantiated from the same application, service, code block, object, library, routine, API, function, etc. Likewise, the same agent, module, program, and/or engine may be instantiated by different applications, services, code blocks, objects, routines, APIs, functions, etc. The terms “agent,” “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a GUI. As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices utilizing virtually any type of technology. Such display devices may be combined with processing circuitry 502, volatile memory 504, and/or non-volatile storage device 506 in a shared enclosure, or such display devices may be peripheral display devices.

When included, input subsystem 510 may comprise or interface with one or more user-input devices such as a keyboard, mouse, touch screen, camera, or microphone.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 500 to send and/or receive messages to and/or from other devices via a network such as the Internet.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for probabilistic classification of tax categories, comprising:
processing circuitry configured to execute instructions using portions of associated memory to implement a probabilistic tax category classification program, wherein the processing circuitry is configured to:
receive a query to determine a tax category for a product, the query including product information related to the product;
send a prompt to a tax category prediction language model, the prompt including the product information and instructing the tax category prediction language model to predict a tax category for the product based on the product information;
receive, as output from the tax category prediction language model, a subset of tax categories of a plurality of tax categories with respect to a tax category classification of the product, and respective probability scores for each tax category of the subset of tax categories;
implement a calibration and probabilistic classification module to calibrate the respective probability scores output by the tax category prediction language model, the calibration and probabilistic classification module being configured to:
generate a posterior probability distribution by incorporating historical accuracy data for each tax category of the subset of tax categories;
determine an entropy of the posterior probability distribution;
determine a variance of the posterior probability distribution; and
calculate a respective combined confidence score for each tax category of the subset of tax categories by combining the posterior probability distribution, the entropy of the posterior probability distribution, and the variance of the posterior probability distribution;
receive an output pair from the calibration and probabilistic classification module, the output pair comprising a predicted tax category and its respective combined confidence score; and
based on the combined confidence score for the predicted tax category, output a final tax category for the product.

2. The computing system of claim 1, wherein
when the combined confidence score for the predicted tax category is below a predetermined threshold value, the processing circuitry is configured to implement a human-in-the-loop engagement module to trigger human review of the predicted tax category prior to output of the final tax category.

3. The computing system of claim 1, wherein
when the combined confidence score for the predicted tax category is above a predetermined threshold value, the processing circuitry is configured to confirm the predicted tax category as the final tax category.

4. The computing system of claim 1, wherein
each tax category of the subset of tax categories output by the tax category prediction language model is represented by an output token, and
the respective probability scores output from the tax category prediction language model are logarithms of probabilities (logprobs) of log-odds units (logits) for each tax category output token.

5. The computing system of claim 1, wherein
the posterior probability distribution is generated via Bayesian inference.

6. The computing system of claim 1, wherein
in a training phase, the tax category prediction language model is trained on training data pairs comprised of product information input and tax category ground truth output.

7. The computing system of claim 1, wherein
the historical accuracy data for each tax category of the subset of tax categories is acquired from prior predicted tax category and combined confidence score pairs output by the calibration and probabilistic classification module, and from ground truth testing during a training phase.

8. The computing system of claim 1, wherein
the processing circuitry further is configured to implement a product data enrichment module to perform multi-source data aggregation and semantic enrichment on product descriptions to enable reasoning-based tax categorization of products.

9. The computing system of claim 8, wherein
prior to sending the prompt to the tax category prediction language model, the processing circuitry is configured to implement a prompt engineering and language model reasoning module to ingest enriched product descriptions from the product data enrichment module, construct a context-rich prompt based on product grouping by feature, and record logical steps in each reasoning process for constructing the prompt.

10. A method for probabilistically classifying tax categories, the method comprising:
receiving a query to determine a tax category for a product, the query including product information related to the product;
sending a prompt to a tax category prediction language model, the prompt including the product information and instructing the tax category prediction language model to predict a tax category for the product based on the product information;
receiving, as output from the tax category prediction language model, a subset of tax categories of a plurality of tax categories with respect to a tax category classification of the product, and respective probability scores for each tax category of the subset of tax categories;
implementing a calibration and probabilistic classification module to calibrate the respective probability scores output by the tax category prediction language model by:
generating a posterior probability distribution by incorporating historical accuracy data for each tax category of the subset of tax categories;
determining an entropy of the posterior probability distribution;
determining a variance of the posterior probability distribution; and
calculating a respective combined confidence score for each tax category of the subset of tax categories by combining the posterior probability distribution, the entropy of the posterior probability distribution, and the variance of the posterior probability distribution;
receiving an output pair from the calibration and probabilistic classification module, the output pair comprising a predicted tax category and its respective combined confidence score; and
based on the combined confidence score for the predicted tax category, outputting a final tax category for the product.

11. The method of claim 10, wherein
when the combined confidence score for the predicted tax category is below a predetermined threshold value, the method further comprises:
implementing a human-in-the-loop engagement module to trigger human review of the predicted tax category prior to output of the final tax category.

12. The method of claim 10, wherein
when the combined confidence score for the predicted tax category is below a predetermined threshold value, the method further comprises:
confirming the predicted tax category as the final tax category as the output.

13. The method of claim 10, the method further comprising:
representing each tax category of the subset of tax categories output by the tax category prediction language model by an output token, wherein
the respective probability scores output from the tax category prediction language model are logarithms of probabilities (logprobs) of log-odds units (logits) for each tax category output token.

14. The method of claim 10, the method further comprising:
generating the posterior probability distribution via Bayesian inference.

15. The method of claim 10, the method further comprising:
in a training phase, training the tax category prediction language model on training data pairs comprised of product information input and tax category ground truth output.

16. The method of claim 10, the method further comprising:
acquiring the historical accuracy data for each tax category of the subset of tax categories from prior predicted tax category and combined confidence score pairs output by the calibration and probabilistic classification module, and from ground truth testing during a training phase.

17. The method of claim 10, the method further comprising:
implementing a product data enrichment module to perform multi-source data aggregation and semantic enrichment on product descriptions to enable reasoning-based tax categorization of products.

18. The method of claim 17, the method further comprising:
prior to sending the prompt to the tax category prediction language model,
implementing a prompt engineering and language model reasoning module to ingest enriched product descriptions from the product data enrichment module, construct a context-rich prompt based on product grouping by feature, and record logical steps in each reasoning process for constructing the prompt.

19. A computing system for probabilistic classification of tax categories, comprising:
processing circuitry configured to execute instructions using portions of associated memory to implement a probabilistic tax category classification program, wherein the processing circuitry is configured to:
receive a query to determine a tax category for a product, the query including product information related to the product;
implement a product data enrichment module to perform multi-source data aggregation and semantic enrichment on product descriptions;
implement a prompt engineering and language model reasoning module to group the product with other products based on features identified during semantic enrichment of the product descriptions and generate a context-rich prompt based on the product grouping;
send the prompt to a tax category prediction language model, the prompt including the product information and instructing the tax category prediction language model to predict a tax category for the product based on the product information;
receive, as output from the tax category prediction language model, a subset of tax categories of a plurality of tax categories with respect to a tax category classification of the product, and respective probability scores for each tax category of the subset of tax categories;
implement a calibration and probabilistic classification module to calibrate the respective probability scores output by the tax category prediction language model, the calibration and probabilistic classification module being configured to:
generate a posterior probability distribution via Bayesian inference by incorporating historical accuracy data for each tax category of the subset of tax categories;
determine an entropy of the posterior probability distribution;
determine a variance of the posterior probability distribution via Monte Carlo dropout; and
calculate a respective combined confidence score for each tax category of the subset of tax categories by combining the posterior probability distribution, the entropy of the posterior probability distribution, and the variance of the posterior probability distribution;
receive an output pair from the calibration and probabilistic classification module, the output pair comprising a predicted tax category and its respective combined confidence score; and
based on the combined confidence score for the predicted tax category, output a final tax category for the product, wherein
the respective combined confidence score for the predicted tax category is a highest combined confidence score among the respective combined confidence scores.

20. The computing system of claim 19, wherein
when the combined confidence score for the predicted tax category is below a predetermined threshold value, the processing circuitry is configured to implement a human-in-the-loop engagement module to trigger human review of the predicted tax category prior to output of the final tax category.
